(19) United States
(12) Patent Application Publication
(10) Pub. No.: US 2004/0083130 A1
(43) Pub. Date: Apr. 29, 2004

(54) Electronic toll collection system and method for rental and leased vehicles

(76) Inventors: Arthur Posner, Boca Raton, FL (US); Roslyn S. Posner, Boca Raton, FL (US)

Correspondence Address: Richard C. Litman, LITMAN LAW OFFICES, LTD., P.O. Box 15035, Arlington, VA, 22215, US

(21) Appl. No.: 10/677,792

(22) Filed: Oct. 3, 2003

Related U.S. Application Data
(60) Provisional application No. 60/415,526, filed on Oct. 3, 2002.

(51) Int. Cl. G06F 17/60

(52) U.S. Cl. 705/13; 235/384; 340/928

(57) ABSTRACT

An electronic toll collection system and method for rental vehicles used with known electronic and computerized toll collection systems. The steps of the overall method include registering a rental vehicle that is part of an electronic toll collection system, clearing and resetting the electronic toll collection system upon receipt of a rental vehicle, driving the rental vehicle and accumulating electronic toll collection data and returning the rental vehicle and paying a fee based on the accumulated electronic toll collection data.

### CROSS-REFERENCE TO RELATED APPLICATION

This application claims the benefit of U.S. Provisional Patent Application Serial No. 60/415,526, filed Oct. 3, 2002.

### BACKGROUND OF THE INVENTION

1. Field of the Invention

The present invention relates to an electronic toll collection system and method for rental vehicles.

2. Description of Related Art

Using rental vehicles is a great convenience for people with short-term vehicle needs. Most often rental vehicles are provided to people who are not familiar with the particular city that they are driving the rental vehicle in. Anything that the company issuing the rental car can do to make the customer's use of the rental vehicle easier is greatly appreciated. This amenity and service can include using an automatic toll collection machine or similar toll devices with the rental vehicle.

U.S. Pat. No. 4,123,754 issued to Armstrong, outlines an electronic detection and identification system for use in the rapid identification of vehicles at a toll stop. The system employs an electronic identification card that is carried by the vehicle, to be identified and a fixed transmitter unit that transmits a signal to the card and receives a reflected signal therefrom. The card contains passive resonant circuitry for producing an output signal having a frequency, which is a selected harmonic of the signal transmitted thereto.

U.S. Pat. No. 4,963,723 issued to Masada, outlines the use of an automatic toll collector that has a portion installed at an entrance tollgate and a portion installed at an exit tollgate of a toll road. Each portion has a decoder which recognizes information on the license plate of a vehicle entering the toll gate, and a read and write mechanism, which reads and writes into an IC card, information that is necessary for the collection of tolls.

U.S. Pat. No. 5,144,553 issued to Hassett et al., outlines the use of a system for the automatic collection of tolls, which includes a toll facility and an in-vehicle toll processor having memory for storing available toll money. There is also signal quantity purchased by the user and a toll facility identification site that transmits a toll facility identifier signal indicating the identity of the upcoming toll facility and the toll to be s collected.

U.S. Pat. No. 5,422,473 issued to Kamata, outlines the use of an IC card adaptor having a wireless communication function and/or optical communication function enabling a contact type IC card to be used as an IC card of a non-contact type. The adaptor includes a power supply, a communication processing center, a transmission/reception section and a device for establishing a contact point coupling, with an IC card developing at least a portion of a function, to read data from the IC card and to write data therein through a contact type contact point.

U.S. Pat. No. 5,819,234 issued to Slavin et al., outlines an automatic toll collection system that operates in conjunction with transponders, which are provided for sale to the public in sealed packages and which are pre-approved for a predetermined amount of prepaid toll credit. When the transponders are purchased, they can be installed in any vehicle and are immediately ready for use.

U.S. Pat. No. 5,602,919 issued to Hurta et al., outlines a recognition system of the type, which includes an interrogator and a transponder, and more specifically to such a system in which the interrogator transmits an interrogation signal to the transponder in response to which the interrogator transmits back to the interrogator a response signal. The invention further generally relates to systems and methods implementing smartcards with the recognition system.

U.S. Pat. No. 5,872,525 issued to Fukasawa et al., outlines a toll collection system, which exchanges required information with on-board equipment carried on an incoming vehicle through a radio communication at a tollgate of a toll road.

U.S. Pat. No. 5,969,641 issued to Nakamura et al., outlines the use of a vehicle identification system, and particularly relates to a vehicle identification applicable to the electric toll collection systems provided, with a methodology for measuring the location of a vehicle, by measuring direction of arrival of radio waves transmitted from the vehicle.

U.S. Pat. No. 5,995,898 issued to Tuttle, outlines a system with a vehicle on-board computer and a wireless transponder device coupled to the vehicle on-board computer. The system performs a variety of functions because of its ability to transmit and receive data from other transponders, which may be remote from the vehicle or located in the vehicle, at a location spaced apart from the system.

U.S. Pat. No. 6,019,285 issued to Isobe et al., outlines the use of an automatic toll charging system that communicates by radio between roadside units disposed on each gate of a toll road and a vehicle mounted unit, which automatically charges a toll in a range from an entrance gate to an exit gate. In this system, an integrated circuit (IC) card is inserted in the vehicle mounted unit and payment information recorded on the IC card and entrance information received from a roadside unit, disposed at the entrance gate, are recorded in the information recording part of the vehicle mounted unit.

U.S. Pat. No. 6,040,785 issued to Park et al., outlines the use of a toll collecting system having a lock-type management for toll collection of vehicles in a toll road such as an expressway. The mixed lock-type toll collecting system includes an on-board unit installed in a vehicle, which enters an entrance gate and exits an exit gate of the toll road, for toll collection by radio communication. An entrance lane device is also installed at the entrance gate for transmitting entrance information to the vehicle, which enters the entrance gate.

U.S. Pat. No. 6,042,008 issued to Ando et al., outlines a system to ensure the toll collection of a vehicle carrying an in-vehicle unit, without stopping the vehicle at an entrance tollgate or an exit tollgate. An entrance tollgate lane is equipped sequentially from the entrance with a vehicle class discriminator, an entrance vehicle number reader, a first antenna, a vehicle antennae, a vehicle detector, a ticket issuer, a display unit, a second antenna and a start detector.

U.S. Pat. No. 6,088,680 issued to Hoshino et al., outlines the use of an automatic toll adjusting system, which enables a user to voluntarily select a toll payment with use of a storage medium carried by each user and storing adjustment information necessary for toll adjusting therein. Information is exchanged with the storage medium in radio communication, at a first predetermined frequency at a toll-adjusting gate employing a first toll payment system. At a toll-adjusting gate employing a second toll payment system, information is exchanged with the storage medium in radio communication at a second predetermined frequency, to automatically adjust a toll in the second toll payment system.

U.S. Pat. No. 6,109,525 issued to Blomqvist et al., outlines the use of a system and method of registering vehicles in a road toll facility, which is provided with a radio transmitter and receiver equipment, for microwaves arranged to communicate with vehicle units provided in the vehicles, preferably including a transponder. On command from the road toll facility, an identity is obtained from the in-vehicle unit and a toll debiting operation is performed.

U.S. Pat. No. 6,112,152 issued to Tuttle, outlines the use of a system with a vehicle on-board computer and a wireless transponder device coupled to the vehicle on-board computer. The system performs a variety of functions, because of its ability to transmit and receive data from other transponders, which may be remote from the vehicle or located in the vehicle at a location spaced apart from the system. The remote transponders can be positioned at a gas station, tollbooth, service center, dealership, parking lot or along a roadside.

U.S. Pat. No. 6,337,639 issued to Kojima, outlines the use of a toll collection method of a toll collection apparatus that is jointly installed with a wireless toll collection system, for the toll collection to receive the vehicle data of a vehicle, of which a toll could not be collected by the wireless toll collection system. The toll is collected from the vehicle corresponding to the received vehicle data and transmits the vehicle data to the wireless toll collection system, when the toll collection process is completed.

U.S. Pat. No. 6,339,384 issued to Valdes-Rodriquez, outlines the use of a device for automatically paying a toll for a vehicle passing through a tollbooth. The toll payment device includes a transmitting device and a switch. The transmitting device includes a receiver for receiving a signal from an antenna at the tollbooth, a memory unit for storing identification information associated with the device and a transmitter connected to both the receiver and memory unit for transmitting a signal, including the stored identification information to the antenna, upon receipt of the signal.

U.S. Pat. No. 6,342,844 issued to Rozin, outlines the use of an automatic radio-frequency real-time highway toll collector for moving vehicles. It is especially adapted to the use of an untraceable electronic check debited from a smartcard and communicated in a cryptographically sealed envelope message. The invention relates directly to an in-vehicle unit, non-contact IC card and a roadside collection station and to an overall system incorporating these features.

Although each of the patents outline systems and methods that are useful, novel and unobvious, what is really needed is a method of using a toll collection technology dedicated for rental vehicles. Such a system and method would be welcomed in the marketplace and would be immediately useful for people renting rental vehicles.

None of the above inventions and patents, taken either singularly or in combination, is seen to describe the instant invention as claimed.

### SUMMARY OF THE INVENTION

The invention is an electronic toll collection system and method for rental vehicles used with known electronic toll collection systems. The steps include registering a rental vehicle that is part of an electronic toll collection system, clearing and resetting the electronic toll collection system upon receipt of a rental vehicle, driving the rental vehicle and accumulating electronic toll collection data and returning the rental vehicle and paying a fee based on the accumulated electronic toll collection data.

Accordingly, it is a principal object of the invention to provide a method with an electronic toll collection system that can be used with a rental vehicle.

It is another object of the invention to provide a method with an electronic toll collection system that increases the convenience of using a rental vehicle.

It is a further object of the invention to provide a method of using an electronic toll collection system that reduces traffic congestion and vehicle emissions.

Still another object of the invention is to provide a method of using an electronic toll collection system that reduces the fuel consumption of the rental vehicle.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an electronic toll collection system for rental vehicles according to the present invention.

FIG. 2 is an overview of the steps of the overall method of an electronic toll collection method for rental vehicles.

Similar reference characters denote corresponding features consistently throughout the attached drawings.

### DETAILED DESCRIPTION OF THE PREFERRED EMBODIMENT

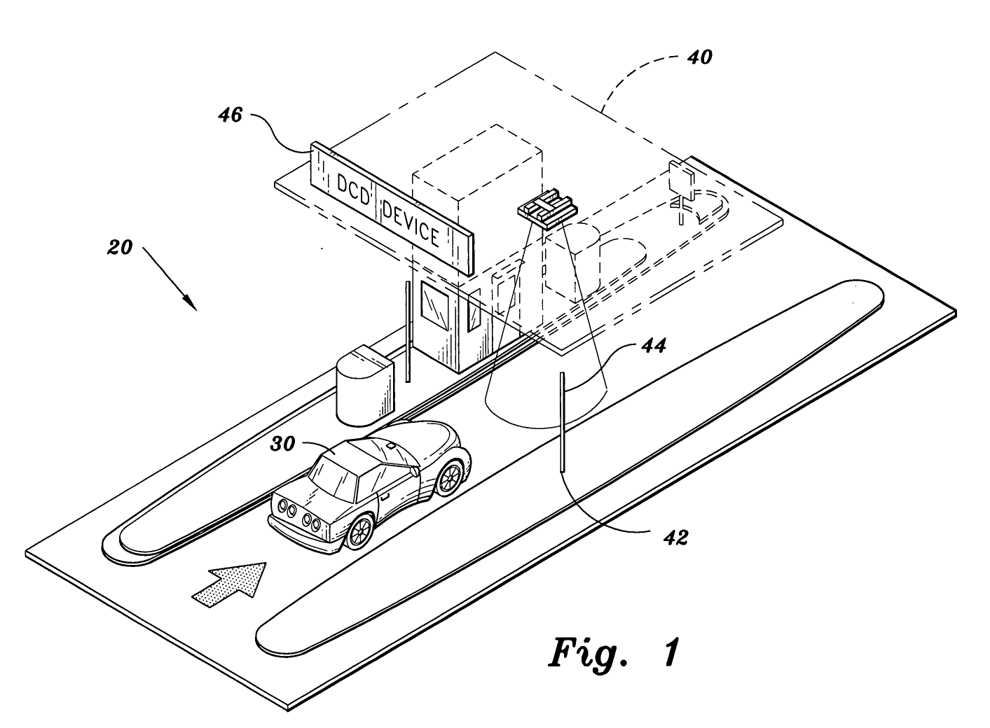

The present invention is an electronic toll collection method for rental vehicles 10. The electronic toll collection method for rental vehicles 10 utilizes any type of electronic toll collection system 20, such as the E-ZPASS electronic toll collection system 20 outlined in U.S. Pat. No. 5,819,234 issued to Slavin et al., or other automatic toll collection systems. An electronic toll collection system 20 includes an electronic tag 30, or similar radio frequency device, installed in each of the rented vehicles, a toll plaza 40 with a transceiver 42 tied into the electronic toll collection system 20 and an antenna 44 and a display sign 46 at the toll plaza 40. The electronic tag 30 contains an electronic chip (not shown) that is installed on a front part of the windshield of the rented vehicle going through the toll plaza 40. An electronic toll collection system 20 and its basic components are depicted in FIG. 1.

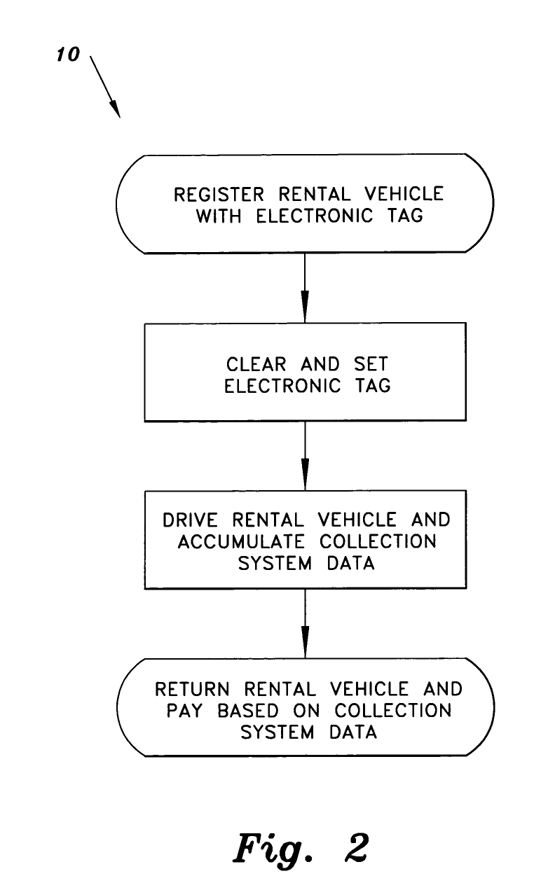

The overall method for the electronic toll collection method for rental vehicles 10 is specific only to rental vehicles being provided with components of an electronic toll collection system 20. Rental vehicles do not include leased vehicles, which are generally used for much longer periods of time than rental vehicles. The overall method for the electronic toll collection method for rental vehicles 10 comprises the following steps of registering a rental vehicle that is part of an electronic toll collection system 20. This specifically includes clearing and resetting the electronic toll collection system 20 upon receipt of a rental vehicle, driving the rental vehicle and accumulating electronic toll collection system data and returning the rental vehicle and paying a fee based on the accumulated electronic toll collection system data. These steps are outlined in the overall method on FIG. 2.

Typically, when a person registers a rental vehicle being provided with the components of an electronic toll collection system 20, a prepaid electronic toll collection system account is established and the person will receive a small electronic tag 30 that is attached to the (inside windshield of the) rental car. Within the small electronic tag 30 is an electronic chip (not shown) that contains information about the person's prepaid electronic toll collection system account. Each time a person driving the rental vehicle uses a toll plaza 40 where the electronic toll collection system 20 is offered, an antenna 44 at the toll plaza 40 reads the rental vehicle and account information contained in the small electronic tag 30. The appropriate toll plaza 40 is then electronically debited from the renter's prepaid electronic toll collection system account, e.g., an electric computerized toll collection system. A final record of these transactions will be given to the renter when his rental vehicle is returned.

At the time that a renter registers a new rental vehicle that is part of an electronic toll collection system 20, the electronic toll collection system 20 should be cleared and reset from any previous renters' transactions upon receipt of the rental vehicle.

Important usage information should also be provided on how to safely use the electronic toll collection system 20. For example, when a renter proceeds through a toll plaza 40 equipped to handle the electronic toll collection system 20, a message sign 46 just beyond the toll plaza 40 will give the renter transaction feedback. If the electronic tag 30 is properly installed, a toll will be deducted from the renter's prepaid account and will prompt the renter to go with a green-lighted “go” or “paid” message. If the electronic tag 30 is improperly installed, the toll amount will not be deducted from the renter's prepaid account. A driver feedback message from the message sign 46 will indicate “toll unpaid” or “call customer service center”. If a renter receives one of these messages in a toll plaza 40 lane, the renter should proceed through the toll plaza 40 and contact the rental company immediately. The renter will still be required to pay the full cash toll when he or she contacts the rental company. Assuming the renter has the electronic tag 30 properly installed in the rental vehicle, the driver of the rental vehicle should continue driving and accumulate electronic toll collection system data. In addition to the cost of the tolls encountered by the renter, the electronic toll collection system data includes the time and date that tolls were encountered. The renter is also subject to safe and lawful conduct with the rental vehicle, including traveling through a toll plaza 40 at the posted speed limit. In the event that a renter enters a toll plaza 40 that is not tied into the electronic toll collection system 20, the renter will still be required to pay the full cash toll while in the toll plaza 40. In an effort to safely operate the rented vehicle, the renter should also never back up in any toll lane unless instructed to do so by toll plaza personnel.

The final step in the overall method of using the electronic toll collection method for a rental vehicle 10 is returning the rental vehicle and paying a fee based on the accumulated electronic toll collection data. When the renter first registers with the electronic toll collection system 20, a prepaid account is typically set-up where the costs of the tolls are deducted from. If a renter sets-up a $25 account and the renter accrues $15 ($10 below the $25 total) an additional $10 will be charged to the renter. Anytime the prepaid account approaches $10, more funds are added to the prepaid account, usually through a renter's credit card. This approach will always insure that there are sufficient funds in the prepaid account. If for some reason the prepaid account cannot be replenished with additional funds, the electronic toll collection system 20 will shutdown and will not pay for any additional tolls.

It is to be understood that the present invention is not limited to the sole embodiment described above, but encompasses any and all embodiments within the scope of the following claims.

We claim:

1. An electronic toll collection system for rental vehicles, each with a front windshield, comprising:
a plurality of electronic tags, with a single electronic tag installed on each of the rental vehicles;
a plurality of toll plazas, each toll plaza having a transceiver which transmits and receive signals from the plurality of electronic tags and a display sign to convey information to the rental vehicles;

2. The system according to claim 1, wherein the electronic tag contains an electronic chip that is installed on the front windshield of the rental vehicle.

3. The system according to claim 1, wherein the transceivers utilize an antenna.

4. An electronic toll collection method for rental vehicles, comprising the following steps:
registering a rental vehicle that is part of an electronic toll collection system;
clearing and resetting said electronic toll collection system upon receipt of a rental vehicle;
driving the rental vehicle and accumulating electronic toll collection data; and
returning said rental vehicle and paying a fee based on the accumulated electronic toll collection data.

5. The method according to claim 4, wherein said electronic toll collection data includes the time and date that tolls were encountered and the cost of tolls encountered.

6. The method according to claim 4, wherein the cost of the tolls encountered is deducted from a prepaid account.

7. The method according to claim 6, wherein the prepaid account has funds automatically added once it reaches $10.

8. The method according to claim 4, wherein important usage information is provided on how to safely use the electronic toll collection system.
